(19) United States
(12) Patent Application Publication
(10) Pub. No.: US 2007/0022311 A1
(43) Pub. Date: Jan. 25, 2007

(54) Electronic equipment system and control method thereof

(75) Inventor: Hee-keun Park, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co. Ltd., Suwon-si (KR)

(21) Appl. No.: 11/447,013

(22) Filed: Jun. 6, 2006

(30) Foreign Application Priority Data
Jul. 21, 2005 (KR) 2005-66467

(51) Int. Cl. G06F 1/00

(52) U.S. Cl. 713/310

(57) ABSTRACT

An electronic equipment supplying power to an external device in response to unique identification information provided by the external device. The electronic equipment includes a power supply supplying power to the external device and a controller controlling the power supply to the external device. Basic power is initially supplied to the external device when the external device is connected to the electronic equipment and additional power may be supplied to the device based on the unique identification information provided by the external device.

### CROSS-REFERENCE TO RELATED APPLICATIONS

This application claims the benefit of Korean Patent Application No. 2005-66467, filed on Jul. 25, 2005, in the Korean Intellectual Property Office, the disclosure of which is incorporated herein by reference.

### BACKGROUND OF THE INVENTION

1. Field of the Invention

Aspects of the present invention relate to an electronic equipment system and a control method thereof, and more particularly, to an electronic equipment system with increased usability and portability, which is capable of supplying driving power to an external device without requiring a separate external power supply for the external device, and a control method thereof.

2. Description of the Related Art

A conventional electronic equipment system is briefly described with reference to FIG. 1. As shown in FIG. 1, the conventional electronic equipment system includes an electronic equipment 10 and an external device 20 connected to the electronic equipment 10. A description will be given in a case where a universal serial bus (USB) device is employed as the external device 20.

The electronic equipment 10 includes a connecting part 11 to which the USB device 20 is connected, a power supplying part 12 supplying driving power to various circuit parts (not shown), which perform various functions of the electronic equipment 10, and the USB device 20 connected to the connecting part 11, and a controller 15 to communicate with the USB device 20 connected to the connecting part 11. The electronic equipment 10 may further include a fuse 13, to cut off driving power supplied from the power supplying part 12 to the USB device 20 when the driving power exceeds a specified value. The fuse 13 operates to limit driving power supplied from the electronic equipment 10 to the USB device 20.

The USB device 20 includes a functional part 27 performing various functions of the USB device 20 and a microcomputer 25 communicating with the controller 15 when connected to the electronic equipment 10 and controlling the functional part 27 under control of the controller 15. The functional part 27 performs various functions of the USB device 20 and includes a functional unit 26 performing relevant functions of the USB device 20 and a bridge interface 28, which is an interface bridging a USB signal between the microcomputer 25 and the functional unit 26.

In the conventional electronic equipment system, a method of supplying the driving power to the USB device 20 when the USB device 20 is connected to the electronic equipment 10 will be described. When the USB device 20 is connected to the connecting part 11 of the electronic equipment 10, the driving power supplied from the power supplying part 12 is supplied to the microcomputer 25 of the USB device 20 through the fuse 13 and then the connecting part 11. Thus, the microcomputer 25 is driven and the USB device 20 is operated by the driving power supplied from the power supplying part 12. In this case, if the USB device 20 requires power more than the driving power supplied from the electronic equipment 10 (for example, more than a limit power of 500 mA), that is, if driving power of the functional part 27 requires high power, the fuse 13 cuts off the power so as not to operate the USB device 20.

In preparation for such a circumference, the conventional electronic equipment system further includes a separate external power supply 30 for supplying separate driving power to the functional part 27 of the USB device 20. Accordingly, in the conventional electronic equipment system, when the USB device 20 is connected to the connecting part 11 of the electronic equipment 10, the power supplying part 12 of the electronic equipment 10 supplies the driving power to the USB device 20, and, if the supplied driving power is insufficient for the USB device 20, the separate external power supply 30 supplies the separate driving power to the USB device 20.

However, as mentioned above, since such a conventional electronic equipment system must employ the separate external power supply 30 in order to supplement power consumption of the USB device 20, if the driving power supplied from the electronic equipment is insufficient for the USB device 20, there is a disadvantage in that portability and usability of the electronic equipment system is deteriorated due to the separate external power supply 30.

### SUMMARY OF THE INVENTION

Accordingly, an aspect of the present invention is to provide an electronic equipment system with increased usability and portability, which is capable of supplying driving power to an external device without requiring a separate external power supply, and a control method thereof.

An electronic equipment system according to an aspect of the invention comprises an external device having unique identification information; and an electronic equipment comprising a power supply for supplying power and a controller controlling the power supply to supply first power to the external device when the external device is connected to the electronic equipment, based on the unique identification information of the external device.

The electronic equipment may further comprise a connecting part to which the external device is connected and the controller. When the external device is connected to the connecting part, the controller controls the power supply to supply specified basic power to the external device and to further supply the first power to the external device based on the unique identification information of the external device.

The controller may store information on an amount of driving power required to drive the external device based on the unique identification information.

The controller may control the power supply to supply the basic power to the external device when the external device is connected to the connecting part, and to further supply the first power to the external device if it is determined that the amount of driving power exceeds the basic power when detecting the information on the amount of driving power of the external device based on the unique identification information provided from the external device.

The power supply may comprise a power supplying part outputting the basic power and the first power, a first switching part transmitting the basic power to the external device, and a second switching part switching on and off the first power output from the power supplying part.

The controller may cause the basic power output from the power supplying part to be supplied to the external device through the first switching part when the external device is connected to the connecting part, and may control the second switching part to supply the first power output from the power supplying part to the external device if it is determined that the amount of driving power of the external device exceeds the basic power when detecting the information on the amount of driving power of the external device based on the unique identification information provided from the external device.

The external device may comprise a device side connecting part connected to the connecting part of the electronic equipment, a functional part performing a function of the external device, and an external device controller providing the unique identification information to the electronic equipment when the basic power is input from the electronic equipment.

The functional part may be operated using the power supplied from the electronic equipment as driving power.

The external device may further comprise a power converting part converting the power supplied from the electronic equipment to be adapted to the functional part and outputting the converted power to the functional part.

The external device controller may cause the unique identification information to be provided to the electronic equipment when the basic power is input from the electronic equipment, and may control the power converting part to convert the power supplied from the electronic equipment to be adapted to the functional part and output the converted power to the functional part.

The external device may be a universal serial bus (USB) device.

According to another aspect of the present invention, a method of controlling an electronic equipment system, including an external device having unique identification information and an electronic equipment connected to the external device and communicating with the external device, comprises determining whether the external device is connected to the electronic equipment; and supplying first power from the electronic equipment to the external device when the external device is connected to the electronic equipment, based on the unique identification information of the external device of the external device.

The method may further comprise supplying specified basic power from the electronic equipment to the external device when the external device is connected to the electronic equipment; and providing the unique identification information from the external device supplied with the basic power to the electronic equipment.

The method may further comprise storing information on the amount of driving power required to drive the external device based on the unique identification information in the electronic equipment.

The electronic equipment may include a second switching part switching on and off the first power supplied to the external device, and the supplying the basic power to the external device may comprise detecting the information on the amount of driving power of the external device based on the unique identification information provided from the external device; and controlling the second switching part to supply the first power to the external device if it is determined that the amount of driving power of the external device exceeds the basic power.

The external device may be a USB device.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a control block diagram of a general electronic equipment system;

FIG. 2 is a control block diagram of an electronic equipment system according to an embodiment of the present invention; and

FIG. 3 is a control flow chart of a method of controlling an electronic equipment system according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

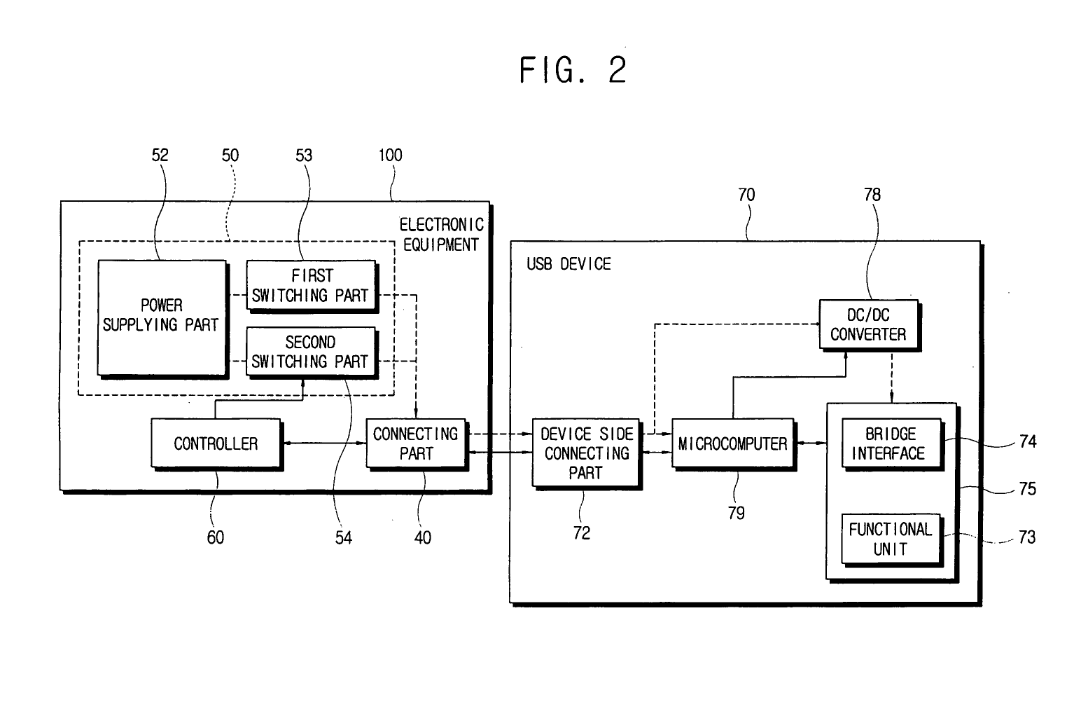

FIG. 2 is a control block diagram of an electronic equipment system according to an embodiment of the present invention. As shown in FIG. 2, the electronic equipment system includes an electronic equipment 100 and an external device 70 connected to the electronic equipment 100. A description will be given to a case where a USB device is employed as the external device 70.

The electronic equipment 100 includes a connecting part 40 to which the USB device 70 as the external device is connected, a power source 50 supplying driving power to various circuit parts (not shown), which perform various functions of the electronic equipment 100, and a controller 60 to communicate with the USB device 70 connected to the connecting part 40. The electronic equipment 70 may be a host device such as a portable computer.

The power source 50 supplies driving power to the circuit parts (not shown) and the USB device 70 connected to the connecting part 40. The power source 50 includes a power supplying part 52 outputting basic power (for example, 5V, 500 mA) and first power (for example, 5V, 500 mA), a first switching part 53 supplying the basic power to the USB device 70 connected to the connecting part 40, and a second switching part 54 switching on and off the first power output from the power supplying part 52.

The first switching part 53 cuts power to the USB device 70 when the basic power supplied from the power supplying part 53 to the USB device 70 exceeds a specified value (for example, a limit current of 500 mA). The first switching part 53 operates to limit power supplied from the electronic equipment 100 to the external device (USB device 70).

The second switching part 54, which is switched on/off under control of the controller 60, controls the first power to be supplied from the power supplying part 52 to the external device (USB device 70). The second switching part 54 may be prepared as various types of switches such as a relay switch or a transistor.

The controller 60 may store information on the amount of driving power required to drive external devices based on unique identification information of the external devices. When the USB device 70 is connected to the connecting part 40, the controller 60 controls the basic power to be supplied to the USB device 70 and detects the information on the amount of driving power required by the connected USB device 70 based on the unique identification information provided from the connected USB device 70. On determining that the amount of driving power of the connected USB device 70 exceeds the basic power, the controller 60 controls the second switching part 54 to further supply the first power as additional power to the USB device 70.

More specifically, when the USB device 70 is connected to the USB device 70, the controller 60 controls the basic power, which is output from the power supplying part 52, to be supplied to the USB device 70 through the first switching part 53. Thereafter, the controller 60 determines whether the amount of driving power of the USB device 70 based on the unique identification information provided to the electronic equipment 100 exceeds the basic power. If it is determined that the amount of driving power of the USB device 70 exceeds the basic power, the controller 60 controls the second switching part 54 to be switched on so that the first power output from the power supplying part 52 is supplied to the USB device 70. Accordingly, when the amount of driving power required to drive the USB device 70 exceeds the basic power, in addition to the basic power supplied to the USB device 70, the electronic equipment 100 supplies the first power to the USB device 70 in order to supplement the basic power.

The USB device 70 includes a device side connecting part 72 connected to the connecting part 40 of the electronic equipment 100, a functional part 75 performing various functions of the USB device 70, a DC/DC converter 78 converting the power supplied from the electronic equipment 100 into a form useable by the functional part 75, and a microcomputer 79 communicating with the controller 60 when connected to the electronic equipment 100 and controlling the functional part 75 under control of the controller 60.

The functional part 75 performs various functions of the USB device 70 and includes a functional unit 73 performing relevant functions of the USB device 70 and a bridge interface 74, which is an interface bridging a USB signal between the microcomputer 79 and the functional unit 73. Construction of the functional unit 73 may vary depending on the kind of the USB device 70, for example, the USB device 70 may be a hard disk drive (HDD) or an optical disk drive (ODD).

The DC/DC converter 78 receives power (the basic power, or a sum of the basic power and the first power) supplied from the electronic equipment 100, converts the received power into a form useable by the functional part 75, and outputs the converted power to the functional part 75.

The microcomputer 79, which is a controller of the USB device 70, communicates with the controller 60 of the electronic equipment 100 and controls the functional part 75 under control of the controller 60. When the USB device 70 is connected to the connecting part 40 and is input with the basic power from electronic equipment 100, the microcomputer 79 is initially driven by the basic power. The microcomputer 79 driven by the basic power provides its unique identification information to the electronic equipment 100. In addition, the microcomputer 79 controls the DC/DC converter 78 to convert the power supplied from the electronic equipment 100 into a form useable by the functional part 75.

In the electronic equipment system of the present invention as shown in FIG. 2, the USB device 70 is configured to convert the power supplied from the electronic equipment 100 into a form useable by the functional part 75 through the DC/DC converter 78 and supply the converted power to the functional part 75. Alternatively, if driving power of the functional part 75 has a same magnitude as the power supplied from the electronic equipment 100, in the USB device 70, the basic power and/or the first power supplied from the electronic equipment 100 may be directly supplied to the functional part 75 without any conversion of the power through the DC/DC converter 78.

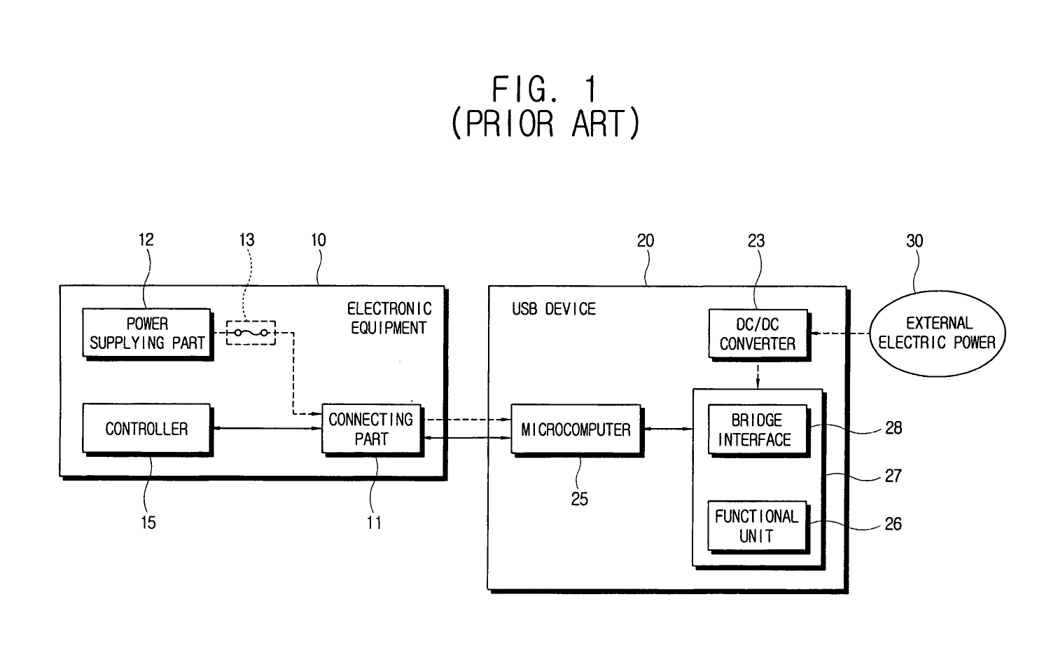

Accordingly, since the electronic equipment 100 supplies the additional first power to the USB device 70 in order to supplement power consumption of the USB device 70, which is unsatisfied with the basic power supplied from the electronic equipment 100, the electronic equipment system of the present invention can overcome the conventional problem that the separate external power supply (30 in FIG. 1) for supplying additional power to the USB device 70 must be provided.

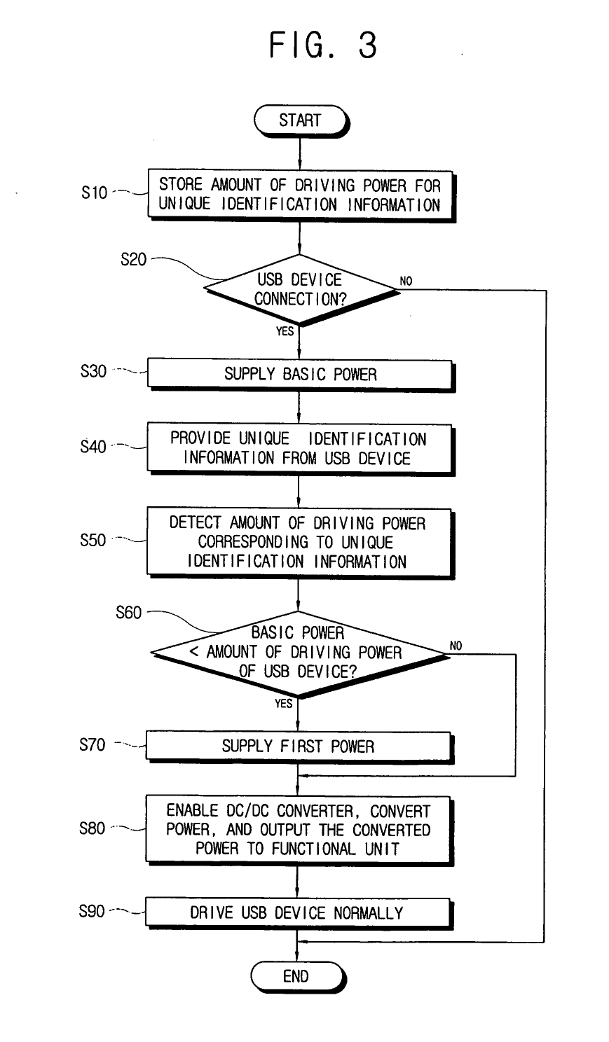

A method of controlling the electronic equipment system shown in FIG. 2 will be described with reference to FIG. 3. The controller 60 of the electronic device 100 stores information on an amount of driving power required to drive an external device based on unique identification information of the external device at operation S10. The controller 60 determines whether any external device (e.g., USB device 70) is connected to the connecting part 40 at operation S20. If the USB device 70 is connected to the connecting part 40, the controller 60 controls the basic power supplied from the power supplying part 53 to be supplied to the USB device 70 through the first switching part 53 at operation S30. Thus, the microcomputer 79 of the USB device 70 is supplied with the basic power supplied from the electronic equipment 100 starts operation and outputs the unique identification information of the USB device 70 to the electronic equipment 100 at operation S40. Then, the controller 60 receives the unique identification information from the USB device 70 and determines the amount of driving power corresponding to the unique identification information of the connected USB device 70 by comparing the unique identification information with the pre-stored information on the amount of driving power required for an external device having the unique identification information at operation S50. Then, the controller 60 compares the basic power with the detected amount of driving power to determine whether the amount of driving power of the USB device 70 exceeds the basic power at operation S60.

If it is determined in operation S60 that the amount of driving power of the USB device 70 exceeds the basic power, the controller 60 controls the second switching part 54 to be switched on so that the first power output from the power supplying part 52 is supplied to the USB device 70 at operation S70. If it is determined in operation S60 that the amount of driving power of the USB device 70 does not exceed the basic power, the controller 60 controls the second switching part 54 to be switched off so that the first power output from the power supplying part 52 is not supplied to the USB device 70. Accordingly, if the amount of driving power required to drive the USB device 70 exceeds the basic power, the electronic equipment 100 further supplies the first power to the USB device 70 in order to supplement the basic power being supplied to the USB device 70.

When the first power is additionally supplied, the microcomputer 79 enables the DC/DC converter 78 and controls the DC/DC converter 78 to convert the power supplied from the electronic equipment 100 into a form useable by the functional part 75 of the USB device 70 and to output the converted power to the functional part 75 at operation S80. Accordingly, the USB device 70 is normally driven by the power supplied from the electronic equipment 100 at operation S90.

As described above, in the electronic equipment system of the present invention having the configuration described with respect to FIG. 2 and the control method described with respect to FIG. 3, if the basic power supplied from the electronic equipment 100 is insufficient to satisfy power consumption of the USB device 70, the electronic equipment 100 supplies the additional first power to the USB device 70 in order to supplement power consumption of the USB device 70, thereby the conventional problem that the separate external power supply (30 in FIG. 1) supplying additional power to the USB device 70 must be provided is overcome.

As is apparent from the description, aspects of the present invention provide an electronic equipment system with increased usability and portability, which is capable of supplying driving power to an external device without requiring a separate external power supply, and a control method of controlling a supply of power to an external device.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An electronic equipment system comprising:
an external device having unique identification information; and
an electronic equipment comprising:
a power supply supplying power, and
a controller controlling the power supply to supply first power to the external device when the external device is connected to the electronic equipment, based on the unique identification information of the external device.

2. The electronic equipment system according to claim 1, wherein the electronic equipment further comprises a connecting part to which the external device is connected, and
the controller controls the power supply to supply basic power to the external device, when the external device is initially connected to the connecting part.

3. The electronic equipment system according to claim 2, wherein the controller stores information on an amount of driving power required to drive the external device based on the unique identification information.

4. The electronic equipment system according to claim 3, wherein the controller further controls the power supply to supply the first power to the external device if determined that the amount of driving power exceeds the basic power based on the stored information and the unique identification information provided from the external device.

5. The electronic equipment system according to claim 4, wherein the power supply comprises:
a power supplying part outputting the basic power and the first power,
a first switching part transmitting the basic power to the external device, and
a second switching part switching on and off the first power output from the power supplying part.

6. The electronic equipment system according to claim 5, wherein the controller:
controls the first switching part to supply the basic power output from the power supplying part to the external device, and
controls the second switching part to supply the first power output from the power supplying part to the external device.

7. The electronic equipment system according to claim 4, wherein the external device comprises:
a device side connecting part connected to the connecting part of the electronic equipment,
a functional part performing a function of the external device, and
an external device controller providing the unique identification information to the electronic equipment when the basic power is input from the electronic equipment.

8. The electronic equipment system according to claim 7, wherein the functional part is operated using the basic power and/or the first power supplied from the electronic equipment.

9. The electronic equipment system according to claim 7, wherein:
the external device further comprises a power converting part converting the first power supplied from the electronic equipment to be useable by the functional part and outputting the converted power to the functional part.

10. The electronic equipment system according to claim 9, wherein the external device controller:
causes the unique identification information to be provided to the electronic equipment when the basic power is input from the electronic equipment, and
controls the power converting part to convert the first power supplied from the electronic equipment to be useable by the functional part and output the converted power to the functional part.

11. The electronic equipment system according to claim 10, wherein the external device is a universal serial bus (USB) device.

12. A method of controlling an electronic equipment system including an external device having unique identification information and an electronic equipment connected to the external device and communicating with the external device, the method comprising:
determining whether the external device is connected to the electronic equipment; and
supplying first power from the electronic equipment to the external device when the external device is connected to the electronic equipment, based on the unique identification information of the external device.

13. The method according to claim 12, further comprising:
supplying basic power from the electronic equipment to the external device when the external device is connected to the electronic equipment; and
providing the unique identification information from the external device supplied with the basic power to the electronic equipment.

14. The method according to claim 13, further comprising:
storing information on the amount of driving power required to drive the external device for the unique identification information in the electronic equipment.

15. The method according to claim 14, wherein the supplying of the basic power to the external device comprises:
determining the amount of driving power of the external device based on the unique identification information provided from the external device and the stored information; and
supplying the first power to the external device if it is determined that the amount of driving power of the external device exceeds the basic power.

16. The method according to claim 15, wherein the external device is a USB device.

17. A universal serial bus (USB) device operative with a host device, the USB device comprising:
a controller, operative from basic power provided by the host device, storing unique identification information of the USB device and communicating the unique identification information to the host device in response to an initial input of the basic power;
a functional part performing a function of the USB device, and
a DC/DC converter converting additional power supplied by the host device to a form useable by the functional part of the USB device, in response to the communication of the unique identification information to the host device, wherein the additional power is supplied to the USB device by the host device where the host device determines, based on the unique identification information, that the basic power is not sufficient to operate the USB device.

18. A host device, comprising:
a USB port through which an external device is operable;
a first switching part switching a basic power input to the external device;
a second switching part switching an additional power input to the external device; and
a controller controlling the first and second switching parts, wherein the controller:
determines power requirements of the external device based on unique identification information provided from the external device through the USB port in response to the basic power being supplied to the external device, and
controls the second switching part to supply the additional power to the external device, if the controller determines that the power requirements of the external device are greater than a capacity of the basic power.
